(19) United States
(12) Patent Application Publication
(10) Pub. No.: US 2006/0270393 A1
(43) Pub. Date: Nov. 30, 2006

(54) System and method using SMS messaging for wireless conference calls

(76) Inventors: Baoling S. Sheen, Naperville, IL (US); David S. Benco, Winfield, IL (US); Kevin J. Overend, Elmhurst, IL (US); Sandra Lynn True, St. Charles, IL (US); Kenneth J. Voight, Sugar Grove, IL (US)

Correspondence Address: FAY SHARPE/LUCENT, 1100 SUPERIOR AVE, SEVENTH FLOOR, CLEVELAND, OH, 44114, US

(21) Appl. No.: 11/137,765

(22) Filed: May 25, 2005

(51) Int. Cl. H04M 3/42

(52) U.S. Cl. 455/416; 455/466

(57) ABSTRACT

A method of forming a conference call between a call session party mobile terminal engaged in a call session and an invited party mobile terminal is provided. The method includes sending an SMS invitation message from the call session mobile terminal to the invited party mobile terminal inviting the invited party to join the call session, receiving an SMS reply message from the invited party mobile terminal accepting the invitation to join the call session, associating the invited party mobile terminal with the call session, and bridging the invited party mobile terminal into the call session. A system for performing this SMS based conference call feature is also provided.

### BACKGROUND OF THE INVENTION

This invention relates to a system and method for establishing a conference call with a wireless telecommunications mobile terminal using Short Message Service (SMS) messaging.

The invention the telecommunications arts, and more particularly to wireless telecommunications mobile terminals capable of sending and receiving SMS messages.

Telecommunications systems have for years enabled parties to communicate effectively in a call session which connects telecommunications terminals together. Wireless telecommunications systems can now connect these parties while enabling them to move about freely.

Wireless telecommunications providers are continually looking for new ways to satisfy the needs of their customers, also referred to as subscribers. Short Message Service (SMS) messages have been established to meet the need of sending short text based messages. Subscriber can use their mobile terminals to send SMS messages to other mobile terminals and can receive SMS messages on their mobile phones.

Conference calling is an effective form of communication which enables multiple parties to communicate by connecting three or more telecommunication terminals together in a call session. Each party connected in the conference call has full duplex communication enabling them to hear and talk with everyone else in the call session.

Typically, when one of the parties engaged in a call session wanted to have other parties join the call session, they needed to put the other parties already engaged in the call session on hold and call the other parties to invite them to join. This procedure is ungainly and can disrupt conversation while these parties wait for the inviting party to accomplish this task.

The present invention contemplates a new and improved system and method that resolves the above-referenced difficulties and others.

### SUMMARY OF THE INVENTION

A system and method for forming a conference call between a call session party mobile terminal engaged in a call session and an invited party mobile terminal are provided.

In one aspect of the invention the method includes sending an SMS invitation message from the call session mobile terminal to the invited party mobile terminal inviting the invited party to join the call session, receiving an SMS reply message from the invited party mobile terminal accepting the invitation to join the call session, associating the invited party mobile terminal with the call session, and bridging the invited party mobile terminal into the call session.

In accordance with another aspect of the invention, the system includes means for sending an SMS invitation message from the call session mobile terminal to the invited party mobile terminal inviting the invited party to join the call session, means for receiving an SMS reply message from the invited party mobile terminal accepting the invitation to join the call session, means for associating the invited party mobile terminal with the call session, and means for bridging the invited party mobile terminal into the call session.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a wireless telecommunications system including a system for forming a conference call in accordance with the invention;

FIG. 2 is a block diagram illustrating a portion of two wireless telecommunications systems including a system for forming a conference call in accordance with the invention;

FIG. 3 is a flow chart illustrating a method for forming a conference call in accordance with the invention; and

FIG. 4 is a flow chart illustrating a method for forming a conference call in accordance with the invention.

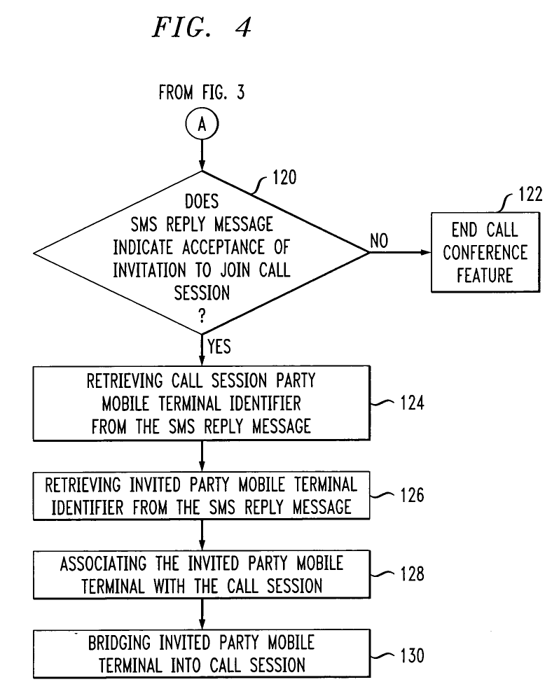

### DETAILED DESCRIPTION OF THE PREFERRED EMBODIMENTS

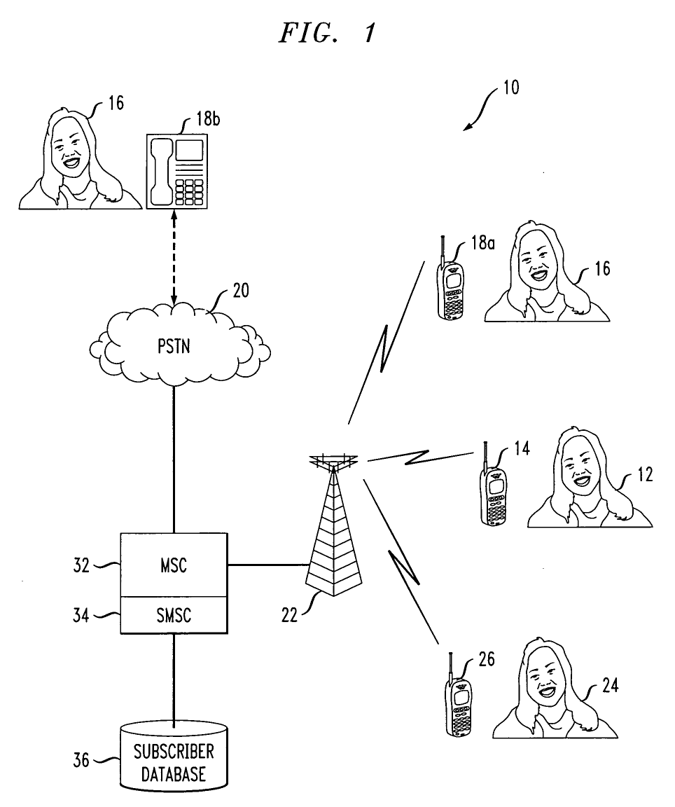

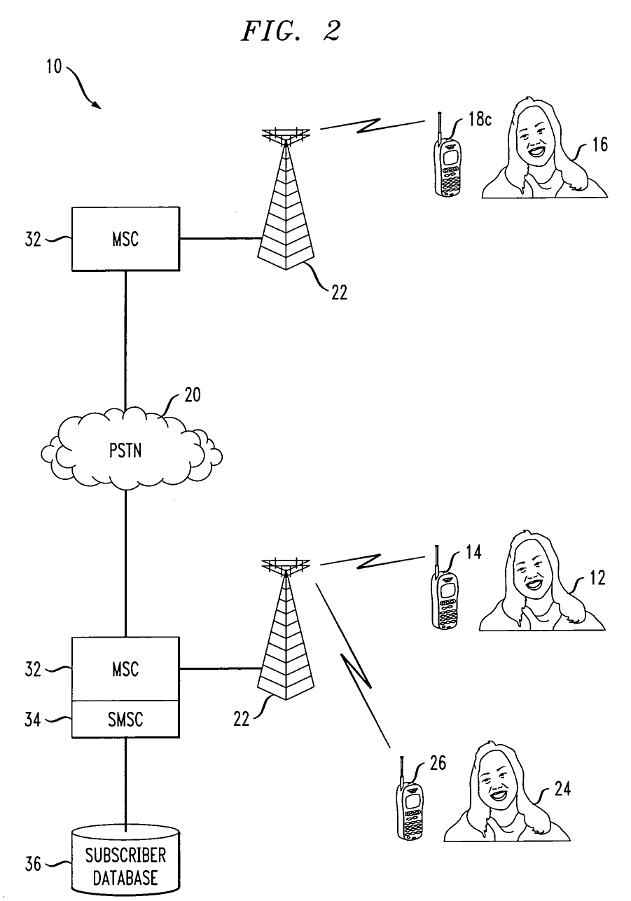

Referring now to FIGS. 1 and 2, a portion of a wireless communication network is shown generally at 10 for providing wireless telecommunications services to a first party 12 using a first mobile terminal 14, also referred to as the first mobile terminal, or first terminal. The first mobile terminal 14 is also known as a mobile phone, a mobile handset, or a cellular phone. The wireless telecommunications network 10 enables the first party 12 to communicate with a second party 16 via a call session connecting the first party mobile terminal 14 to a second party terminal 18, also referred to as the second terminal. The second terminal 18 can be a mobile terminal 18a using the wireless network 10, a landline terminal 18b or other terminal using the Public Switched Telephone Network (PSTN) 20, or a mobile terminal 18c using a wireless telecommunications network and the PSTN 20 (as shown in FIG. 2) connecting the first and second terminals in the call session.

It is contemplated that the mobile terminals 14 and 18a may utilize the same wireless telecommunications network 10 as is shown in the block diagram of FIG. 1, in that the parties 12, 16 are subscribers to telecommunications services provided by the same wireless telecommunications provider (not shown). Alternatively, as shown in FIG. 2, the mobile terminals 14, 18c may utilize the different wireless telecommunications networks for communicating with each other across the Public Switched Telephone Network (PSTN) 20.

The wireless telecommunications network includes a base station 22, as shown in FIG. 1, for providing over-the-air telecommunications to the mobile terminals 14, 18a, 18c. It should be appreciated that the mobile terminals 14, 18a, 18c may be separated by sufficient distance so as to utilize separate base stations 22, as is known in the art. Further, it should be appreciated that the mobile terminals 14, 18 may utilize different base stations 22, as shown in FIG. 2, each belonging to different wireless telecommunications providers for communicating with each other.

As shall be described in further detail below a third party 24 communicates with the first terminal 14 and second terminal 18a, 18b, or 18c via a wireless network 10 using a third party mobile terminal 26, also referred to as the third terminal 26. The third terminal 26 can communicate using the same wireless network 10 as the first terminal 14, or another wireless network connected thereto. The first and third terminals 14, 26 are capable of sending and receiving Short Message Service (SMS) messages as described below.

The wireless telecommunications network 10 also includes a Mobile Switching Center (MSC) 32 responsible for handling the wireless communications to and from the mobile terminals 14, 18a including such known functions as call setups and call routing, among others. The MSC 32 is typically connected to several base stations 22, each providing coverage for different geographic areas so as to provide over-the-air communications between the MSC and wireless terminals located near them.

The MSC 32 can transmit data and/or text messages to the mobile terminals 14, 18, as is known in the art. For example, the MSC 32 can include, or is connected to, a Short Message Service Center (SMSC) 34 for sending SMS messages to the mobile terminals 14, 18a as described below.

The wireless telecommunications network 10 also includes subscriber database 36. The subscriber database can be disposed at the MSC 32, or on other nodes in the network 10. The subscriber database 36 can include individual subscriber records, current status of subscribers, and information on call routing and billing. The subscriber database 36 can include databases known as the Home Location Register (HLR) and the Visitor Location Register (VLR). The HLR contains subscriber profiles, while the VLR provides information relevant to roamers which can be obtained from the roamer's HLR. The subscriber database 36 can include the features which the subscriber subscribes to and can be used to determine whether a subscriber, such as the call session party 12, is authorized to use the conference call feature described herein.

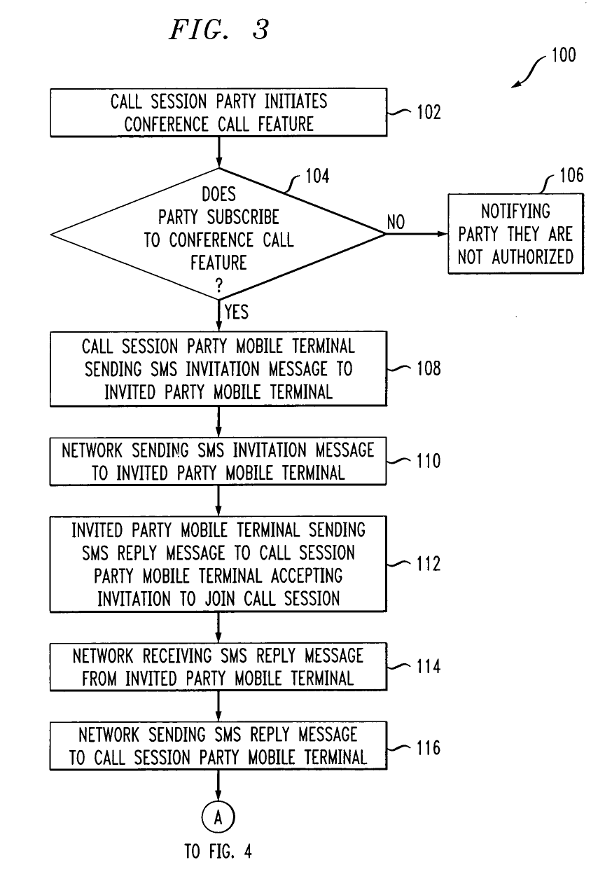

Referring now to FIG. 3, a method of forming a conference call between a call session party mobile terminal 14 engaged in a call session and an invited party mobile terminal 26 is shown generally at 100. For the purposes of this example, the MSC 32 responsible for handling the calls of the call session party mobile terminal 14 shall be performing the operational tasks of the conference call feature described below unless stated otherwise. However, it should be appreciated that an application server connected to the MSC 32 may also perform these conference call feature operations.

A party 12, referred to as the call session party, is engaged in a call session, also referred to as an on-going call session, with one or more other parties, only one of which is shown at 16 for simplicity. Thus, the call session connects the call session party mobile terminal 14 with one or more other terminals 18. As described above, these other terminals can be mobile terminals 18a, 18c, POTS landlines 18b, and Voice Over Internet Protocol terminals, among others.

The call session party 12 wishes to invite one or more other parties 24 to join the call session and therefore initiates the conference call feature using their mobile terminal 14 at 102 while still engaged in the call session. This can be accomplished in any suitable known manner such as for example by pressing a function key on the call session party mobile terminal 14 which communicates to the MSC 32 that the call session party 12 wants to initiate the conference call feature. The MSC 32 determines whether the call session party 12 has authorization to use the conference call feature at 104 by, in this example, checking with the subscriber database 36. As described above, the subscriber database stores the features the call session party 14 subscribes to including the conference call feature described herein. If it is determined that the call session party 12 does not subscribe to the conference call feature, and is therefore not authorized, the MSC 32 sends a message back to the call session party mobile terminal 14 indicating such at 106.

If it is determined that the call session party 12 is authorized to use the conference call feature at 104, the method also includes, at 108, the call session party 12 sending an SMS invitation message to the party, or parties, the call session party wants to invite to join the call session. The call session party 12 uses his/her call session party mobile terminal 14 to send the SMS invitation message(s) to the mobile terminals 26 of these one or more invited parties while the call session party is still engaged in the call session. For the purposes of simplicity, the example provided herein includes the call session party 12 inviting one invited party 24, who is using an invited party mobile terminal 26, to join the call session. However, it should be appreciated that a plurality of different parties, each using a mobile terminal, can be invited to join the call session and bridged into the call session in a similar manner.

The SMS invitation message is sent via the SMSC 34 and routed to the invited party mobile terminal 26 through the MSC 32. The SMS invitation message can be a pre-established SMS message stored either in the call session party mobile terminal 14 or on a node in the wireless telecommunications network 10, such as for example in the subscriber database 36, among others. The SMS invitation message includes an invitation inviting the recipient to join an on-going call session. The SMS invitation message can include the name of the call session party 12 and, if desired, the names of the other party or parties 16 also engaged in the on-going call session. The SMS invitation message can include other information which may be useful for the invited party 24 to know, if so desired, such as for example, the purpose of the call session.

The MSC 32 responsible for handling calls for the call session party 12 sends the SMS invitation message, routing it to the invited party mobile terminal 26 in a known manner, at 110. The invited party 24 receives the SMS invitation message on the invited party terminal 26 and responds by sending an SMS reply message back to the call session party terminal 14 at 112. The SMS reply message can include an indicator, such as SMS text including “YES” or other text, or a flag, or other known indicators, which can be recognized by the MSC as indicating that the invited party wants to join the call session. Alternatively, the SMS reply message itself can be such an indicator.

The method also includes the MSC 32 receiving the SMS reply message from the invited party mobile terminal 26 across the network 10 at 114 and routing it to the call session party mobile terminal 14 at 116. This routing can be accomplished using the call session party mobile terminal 14 phone number found in the SMS reply message.

The method also includes at 120 the MSC 32 determining that the SMS reply message indicates acceptance of the invitation to join the call session, that is to say, that the invited party does wish to join the call session. The MSC 32 can determine that the SMS reply message includes the indicator as described above in any suitable known manner. Alternatively, if the acceptance indicator is considered to be inherent in the SMS reply message, because the invited party is only asked respond with an SMS reply message if they want to join the call session if the MSC 32, the MSC can determine acceptance of the invitation to join by receiving the SMS reply message. It should be appreciated that the MSC 32 can determine that the SMS reply message indicates acceptance of the invitation to join the call session by using other acceptance indicators, such as a flag, or other known techniques.

If it is determined that the invited party 24 does not want to accept the invitation to join the call session at 120 the conference call feature can end at 122. If it is determined at 120 that the SMS reply message indicates acceptance of the invitation to join, such as by including the indicator, the conference call feature continues.

The method 100 also includes the MSC 32 retrieving a call session party mobile terminal identifier from the SMS reply message, or from call routing messaging associated therewith, at 124. The call session party mobile terminal identifier can be the Mobile Identity Number (MIN) or phone number of the call session party mobile terminal 14 or other identifiers used for determining the call session that the call session mobile terminal 14 is engaged in. The method 100 also includes the MSC 32 retrieving an invited party mobile terminal identifier from the SMS reply message, or from call routing messaging associated therewith, at 126. The invited party mobile terminal identifier can be the MIN or phone number of the invited party mobile terminal 26 or other identifiers used for bridging a mobile terminal into a call session. These identifiers can be retrieved in any suitable known manner.

The method also includes at 128 the MSC 32 associating the invited party mobile terminal 26 with the call session. The MSC 32 can use the identifiers, such as the phone numbers, retrieved from the SMS reply message in steps 124 and 126 to associate the invited party terminal 26 with the call session in which the call session party terminal 14 is engaged in. The method 100 also includes the MSC 32 bridging the invited party mobile terminal 26 into the call session at 130 using the association established in 128. The switching capabilities of the MSC 32 enable it to bridge the invited party mobile terminal 26 into the call session in a known manner. As stated above, it should be appreciated that a plurality of different invited party mobile terminals 26 can be bridged into the call session in a similar manner.

The SMS based conference call feature described herein enables parties to invite others to join an established call session without putting parties on hold or otherwise interrupting the call session. Bridging the invited party terminal 26 into the call session upon receiving an SMS reply message does not interrupt the parties 12, 16 already engaged in the conference call. The call session party 12 can easily invite other parties to join the call session by using pre-established SMS invitation messages and sending these messages without inconveniencing the other call session parties already engaged in the call session.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of forming a conference call between a call session party mobile terminal engaged in a call session and an invited party mobile terminal, the method comprising:
sending an SMS invitation message from the call session mobile terminal to the invited party mobile terminal inviting the invited party to join the call session;
receiving an SMS reply message from the invited party mobile terminal accepting the invitation to join the call session;
associating the invited party mobile terminal with the call session; and
bridging the invited party mobile terminal into the call session.

2. The method defined in claim 1 further comprising:
retrieving the invited party mobile terminal identifier from the SMS reply message; and
associating the invited party mobile terminal with the call session using the invited party mobile terminal identifier.

3. The method defined in claim 2 wherein the invited party mobile terminal identifier is the invited party mobile terminal phone number.

4. The method defined in claim 1 further comprising:
retrieving the call session party mobile terminal identifier from the SMS reply message; and
associating the call session party mobile terminal with the call session using the call session party mobile terminal identifier.

5. The method defined in claim 4 wherein the call session party mobile terminal identifier is the call session party mobile terminal phone number.

6. The method defined in claim 1 wherein at least a portion of the SMS invitation message is a pre-established message stored by the call session party mobile terminal.

7. The method defined in claim 1 further comprising determining that the SMS reply message received from the invited party mobile terminal indicates that the invited party is accepting the invitation to join the call session.

8. A system of forming a conference call between a call session party mobile terminal engaged in a call session and an invited party mobile terminal comprising:
means for sending an SMS invitation message from the call session mobile terminal to the invited party mobile terminal inviting the invited party to join the call session;
means for receiving an SMS reply message from the invited party mobile terminal accepting the invitation to join the call session;
means for associating the invited party mobile terminal with the call session; and
means for bridging the invited party mobile terminal into the call session.

9. The system defined in claim 8 further comprising:
means for retrieving the invited party mobile terminal identifier from the SMS reply message; and
means for associating the invited party mobile terminal with the call session using the invited party mobile terminal identifier.

10. The system defined in claim 9 wherein the invited party mobile terminal identifier is the invited party mobile terminal phone number.

11. The system defined in claim 8 further comprising:
means for retrieving the call session party mobile terminal identifier from the SMS reply message; and
means for associating the call session party mobile terminal with the call session using the call session party mobile terminal identifier.

12. The system defined in claim 11 wherein the call session party mobile terminal identifier is the call session party mobile terminal phone number.

13. The system defined in claim 8 wherein at least a portion of the SMS invitation message is a pre-established message stored by the call session party mobile terminal.

14. The system defined in claim 8 further comprising determining that the SMS reply message received from the invited party mobile terminal indicates that the invited party is accepting the invitation to join the call session.
